(19) United States
(12) Patent Application Publication
(10) Pub. No.: US 2016/0018631 A1
(43) Pub. Date: Jan. 21, 2016

(54) HIGH VERSATILE COMBINABLE MICROSCOPE BASE AND MICROSCOPE HAVING THE SAME

(71) Applicant: Lumos Technology Co., Ltd., Taipei (TW)

(72) Inventor: Chih-Yi Yang, Taipei (TW)

(73) Assignee: Lumos Technology Co., Ltd.

(21) Appl. No.: 14/795,610

(22) Filed: Jul. 9, 2015

(30) Foreign Application Priority Data
Jul. 18, 2014 (CN) 201410342876.4

(51) Int. Cl. G02B 21/36; G02B 21/16; G02B 21/26

(52) U.S. Cl. CPC G02B 21/362; G02B 21/26; G02B 21/365; G02B 21/16

(57) ABSTRACT

A combinable microscope base for mounting a light source and a microscopic image capturing device having an optical axis. The light source and the microscopic image capturing device are connected to a display processing device through signal transmission. The light source and the microscopic image capturing device have compatible first and second coupling portions. The combinable microscopic base includes a base body and a main support frame, the main support frame is formed with a placement unit and a main assembly port. The main assembly port is configured such that when the microscopic image capturing device or the light source is mounted therein, the optical axis of the microscopic image capturing device or a main light emitting direction of the light source is oriented toward and corresponds to the placement unit.

### RELATED APPLICATION

The present application claims the benefit of Chinese Patent Application, 201410342876.4, filed on Jul. 18, 2014, the specification of which is incorporated herein by reference.

### FIELD OF THE INVENTION

The present invention relates to a combinable microscope, and a base for use of the combinable microscope.

### DESCRIPTION OF THE RELATED ART

Optical microscopes are an indispensable tool for observing and studying small objects. Optical lenses are employed to magnify small objects that cannot be clearly seen with the human eye so as to permit people to observe at close distance and analyze images that cannot be clearly observed with the naked eye. Conventional optical microscopes generally include a stage, an optical observation lens set, a light source component, and a focus-adjusting component. During operation, a glass plate carrying a specimen to be observed is placed on the stage, and the focus-adjusting component is manipulated so that the specimen can be clearly seen, thereby achieving the objective of observation and study.

Optical microscopes, based on the relative positions of the stage, the optical observation lens set and the light source component thereof, can be classified into upright microscopes and inverted microscopes. The structure of an upright microscope is relatively simple. In the upright microscope, the light source is disposed on a base at the lowermost part to emit light upward toward the stage. After the light passes through the specimen to be observed, an image is formed through the optical observation lens set located above for observation by the operator. Since the optical observation lens set includes a plurality of rotatable objective lenses of different magnification factors and the distance between the objective lenses and the specimen to be observed is relatively short, the operator's manipulation of the stage is often obstructed by the relatively narrow space. In contrast, because the optical observation lens set of the inverted microscope is located below the stage and the light source is caused to emit light downwardly from above, there is a relatively large operation space between the light source and the stage, so that operation of the inverted microscope is relatively convenient. However, the structure of the inverted microscope is hence relatively complicated. Whether it is the upright microscope or the inverted microscope, since the optical observation lens set requires a plurality of optical lenses, the overall manufacture cost of the microscope cannot be reduced considerably.

In addition to being used in ordinary optical microscopes, fluorescence technology currently has been used not only in substantive applications such as industrial inspection, false currency recognition, and criminal identification, but also in cell analysis and tracking in biological research, so that fluorescent microscopic image capturing is becoming more and more important. In a conventional fluorescence microscope, a high-frequency light beam is emitted onto an object having a fluorescent characteristic, such as an anti-counterfeiting security thread in a banknote or a suspected blood stain in a crime scene to thereby excite a fluorescence emission of a relatively low frequency. The fluorescence emission is then directed through a filter assembly, so that a clear fluorescent image of the security thread or the blood stain may be obtained and captured. In addition, in the field of biotechnology, studies in transgenic organisms often involve the introduction of a genetic material that is capable of expressing a fluorescent protein in organisms. The presence or absence of the expressed fluorescent protein in the organisms can help confirm whether or not an exogenous gene of interest has been introduced into the organisms and the expressed protein can serve as a useful marker for tracing the transgenic organisms.

Unfortunately, as only a very small portion of the excitation light will be absorbed by the fluorescent molecules to emit fluorescence, most of the photons of the excitation light will maintain the original wavelength. If the aforesaid optical microscope structure is adopted such that the object to be observed is interposed between the light source and the optical observation lens set, once some excitation light passes through the object to be observed and reaches the optical observation lens set, the image information of the fluorescence will be completely overwhelmed, thereby considerably increasing the experiment failure rate. Therefore, the structure of the fluorescence microscope is mainly designed to have a reflective light path such that, after the light source emits light to the object to be observed, the fluorescence signal is caused to return to the optical observation lens set following the same path.

However, as the excitation light is mainly reflected directly by the surface of the object to be observed, with a small portion thereof scattering in all directions, and as the fluorescence is released after a very small portion of the excitation light reaches and is absorbed by the fluorescence molecules, the intensity of the fluorescence signal is oftentimes far lower than that of the excitation light. During observation or capturing of images, regardless of whether it is directly reflected excitation light or scattered excitation light, it is regarded as a noise signal that interferes with the fluorescence signal. When the noise signal is greater than the actual signal hundreds or thousands of times, this poses a very big problem for image processing.

Furthermore, most microscope manufacturers specialize in optics design and typically deal with the signal-to-noise ratio (S/N ratio) problem by merely increasing the number of optical elements, for example, by using a better filter lens to filter out excitation light. However, even the use of a high-quality filter lens will result in weakening of the fluorescence signal. Therefore, it is necessary to increase the intensity of the light source. Particularly, when the light source is at a distance from the observation position, the intensity of the light irradiated on the object to be observed will decrease with distance, making it imperative to have the fluorescence microscope to be equipped with a light source with extremely high intensity, and to adopt a plurality of filter lenses with an optimum filtering effect. In some instances, due to the excessively high intensity of light emitted by the light source, the proteins of tiny objects to be observed, such as zebrafish, have even been denatured (cooked) by excessive irradiation with incident excitation light. On the other hand, increasing cost of optical components and demands for high quality have resulted in high-priced fluorescence microscopes that could cost a million RMB.

Laboratories generally have tightly controlled budgets and cannot purchase diverse optical microscopes or costly fluorescence microscopes without limits. Very often, an ordinary optical microscope is used to conduct observation experiments, or a few costly instruments are used in turn by a number of people, which unduly hamper or delay the process of research and experimentation. To resolve such problems, the Applicant has proposed several fluorescence microscopes with a dark field optical construction in which excitation light is configured to irradiate on the object to be observed from the side so as to permit observation from above or below. As a general rule, an angle between the light source and the observation direction is configured to be not exceeding 45 degrees. An immediate benefit of such construction is that directly reflected excitation light is completely eliminated from the optical path observed, so that the noise which needs to be filtered out is primarily the outside background light and scatteredly reflected excitation light. In addition, the Applicant has, in several co-pending applications, proposed arranging the light source as close to the object to be observed as possible so as to reduce light loss along the path to thereby render use of light-emitting diodes (LEDs) feasible.

Accordingly, the present invention aims to achieve the objective of combining the upright microscope, the inverted microscope, and the fluorescence microscope into one in response to the needs of operators, particularly using the already commercialized, economical and mature apparatuses to work in conjunction with a combinable microscope base proposed in the present invention so that the stage, optical observation lens set, and light source components can be freely assembled to considerably enhance the operational flexibility for observers in experiments, and to allow change of the relative positions of the components at will to thereby meet diverse experimental needs, enhance the overall efficiency of experiments, considerably reduce the cost of experimental apparatus, and lower the so-called research threshold.

### SUMMARY OF THE INVENTION

An object of the present invention is to provide a combinable microscope base for easy assembly of optical microscope components to enhance the use flexibility of the optical microscope and effectively reduce experiment cost.

Another object of the present invention is to provide a combinable microscope base in which, through an elevating unit that guides upward and downward displacement of a placement unit, the space of the placement unit would not be limited.

A further object of the present invention is to provide a microscope having the combinable base, in which an excitation light source is mounted on an auxiliary support frame, and an angle adjusting member is disposed to eliminate the prior art problem that, due to direct reflection of light from the excitation light source, directly reflected light overshadows the fluorescence that needs to be observed in experiments. Furthermore, by using an auxiliary light source to irradiate light on the object to be observed, the efficiency and accuracy of experiments can be enhanced.

Still another object of the present invention is to provide a microscope having a combinable base in which a light emitting diode (LED) light source can be disposed as close to an object to be observed as possible so as to reduce light loss along the path.

Yet another object of the present invention is to provide a microscope having a combinable base, which utilizes two microscopic image capturing devices to capture images from different angles to thereby enhance accuracy in experiment operation.

To achieve the aforesaid objects, the present invention provides a combinable microscope base for mounting a light source and a microscopic image capturing device having an optical axis. The light source and the microscopic image capturing device are connected to a display processing device through signal transmission, and the light source and the microscopic image capturing device respectively have a first coupling portion and a second coupling portion that are compatible with each other. The combinable microscope base includes: a base body; and a main support frame secured to the base body and extending upwardly and downwardly along a corresponding gravitational direction. The main support frame is formed with a placement unit and a main assembly port. The placement unit is disposed to secure and support an object to be observed. The main assembly port matches the first coupling portion and the second coupling portion for mounting the microscopic image capturing device or the light source. The main assembly port is configured such that when the microscopic image capturing device or the light source is mounted, the optical axis of the microscopic image capturing device or a main light emitting direction of the light source is oriented toward and corresponds to the placement unit.

By combining the aforesaid combinable microscope base with a microscope, a microscope having the combinable microscope base can be formed for connection to a display processing device through signal transmission. The microscope comprises: at least one microscopic image capturing device having at least one optical lens, a signal transmitting unit, a power supply unit, and a second coupling portion, the optical lens being disposed to capture an image of an object to be observed, and to output information of the image of the object to be observed to the display processing device through the signal transmission unit; at least one light source for irradiating light toward a position of the object to be observed and having a first coupling portion which is compatible with the second coupling portion; and a combinable microscope base, including: a base body; and a main support frame secured on the base body and extending along an up-and-down direction corresponding to a gravitational direction, the main support frame being formed with a placement unit and at least one main assembly port, wherein the placement unit is disposed to secure and support an object to be observed, and the at least one main assembly port matches the first coupling portion and the second coupling portion and is disposed for mounting at least one said microscopic image capturing device or the light source; wherein the main assembly port which is disposed for mounting at least one said microscopic image capturing device or the light source is configured such that when the at least one microscopic image capturing device or the light source is mounted, the optical axis of the at least one microscopic image capturing device or a main light emitting direction of the light source is oriented toward and corresponds to the placement unit.

Therefore, in a combinable microscope base and a microscope having the base as disclosed herein, the placement unit, the microscopic image capturing device and the light source which are originally fixedly mounted are configured such that their mounting positions can be changed at will. Such a configuration permits the main assembly port of the main support frame to be placed at the center of weight of the entire optical microscope, thereby resolving the prior art problem that the operational space of the placement unit is limited. Furthermore, by virtue of an angle adjustment element, when the excitation light source mounted on an auxiliary support frame irradiates light on the object to be observed, overshadowing of the fluorescence to be observed by directly reflected excitation light can be avoided. In addition, the LED light source can be disposed as close to the object to be observed as possible to reduce light loss along the path. Furthermore, with the use of two microscopic image capturing devices to capture images from different angles, complete images of the object to be observed can be obtained. Thus, the observer can perform the assembly with ease to cope with various test experiments. In addition to enhancing use flexibility of the optical microscope and the efficiency of the experiments, the accuracy of experiments can be improved by the use of the auxiliary light source to irradiate light on the object to be observed.

### BRIEF DESCRIPTION OF THE DRAWINGS

The above and other objects, features and effects of the invention will become apparent with reference to the following description of the preferred embodiments taken in conjunction with the accompanying drawings, wherein like numerals designate similar parts.

FIG. 1 is a schematic view of the structure of a microscope according to a first preferred embodiment of the present invention, illustrating that the relative positions of a microscopic image capturing device, a light source and a placement unit on a main support frame;

FIG. 2 is a side view of the microscope according to the first preferred embodiment of the present invention, illustrating the state of the main support frame;

FIG. 3 is a schematic view of the structure of the microscope according to the first preferred embodiment of the present invention, illustrating adjustment of the placement unit, by virtue of an elevating unit on the main support frame, to displace upwardly and downwardly relative to a base body;

FIG. 4 is a side view of a microscope according to a second preferred embodiment of the present invention, illustrating that a main support frame and an auxiliary support frame form a substantially T-shaped profile;

FIG. 5 is a side view of a microscope according to a third preferred embodiment of the present invention, illustrating pivotal turning of an auxiliary support frame by means of an angle adjusting member;

FIG. 6 is a side view of a microscope according to a fourth preferred embodiment of the present invention, illustrating that a main assembly port of a main support frame is formed with an optical path and is additionally provided with an auxiliary light source and a filter lens; and

FIG. 7 is a side view of a microscope according to a fifth preferred embodiment of the present invention, illustrating that two microscopic image capturing devices have optical axes meeting at and corresponding to a placement unit.

### DETAILED DESCRIPTION OF THE INVENTION

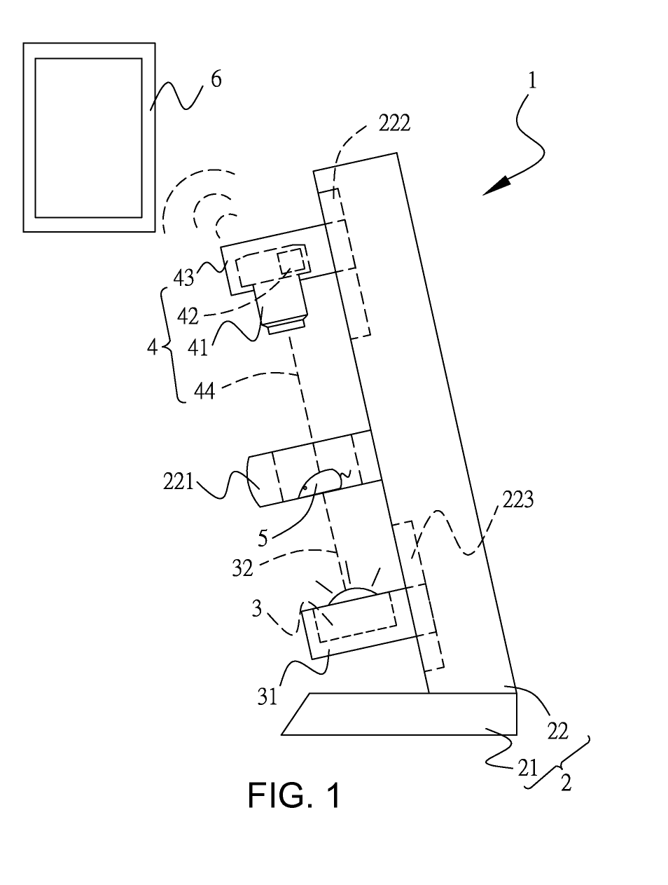

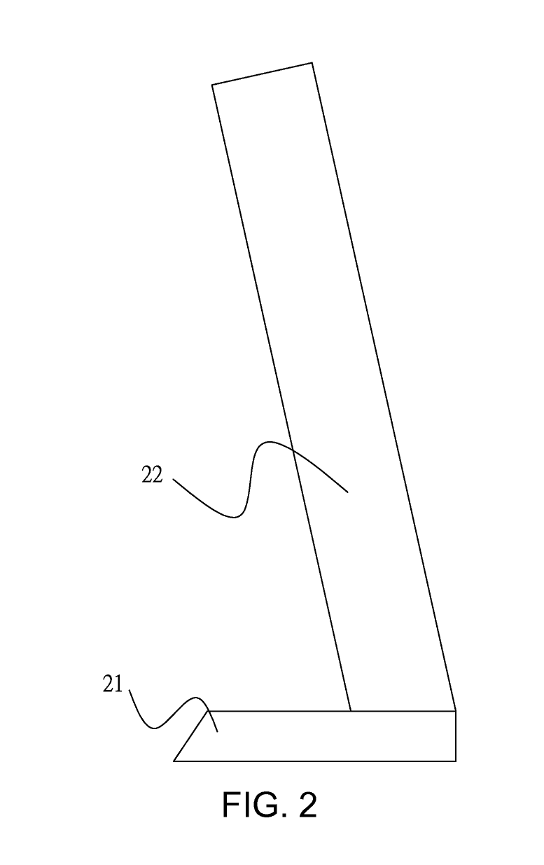

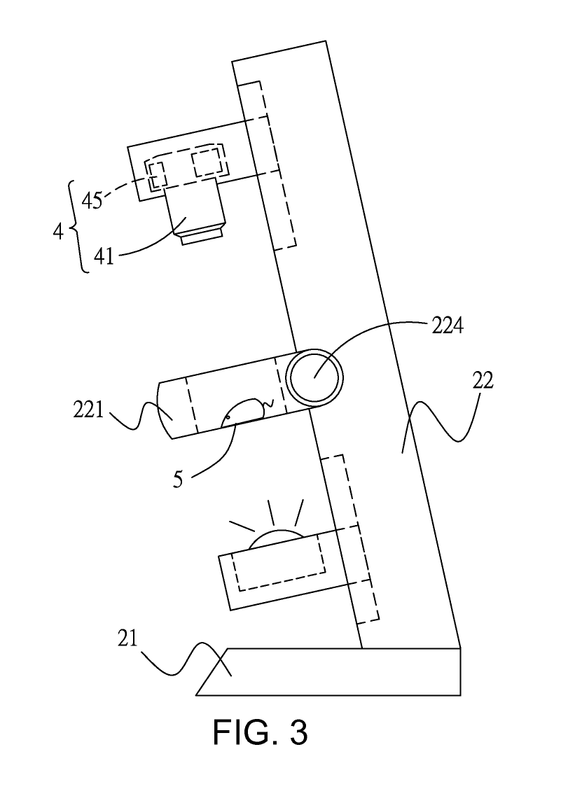

FIGS. 1 to 3 show a microscope 1 according to a first preferred embodiment of the present invention, which includes a combinable microscope base 2, a light source 3 which is exemplified herein as a directional light emitting element, such as a light emitting diode (LED), and a microscopic image capturing device 4, which is exemplified herein as a wireless smart type camera. The combinable microscope base 2 includes a base body 21 and a main support frame 22 secured on the base body 21 and extending along an up-and-down direction corresponding to a gravitational direction. The main support frame 22 is provided with a placement unit 221 which is disposed to support an object 5 to be observed, and which defines a predetermined activity area for the object 5 to be observed. In this embodiment, the object 5 to be observed is exemplified as a mouse. The placement unit 221 is disposed between the light source 3 and the microscopic image capturing device 4. Light from the light source 3 is irradiated on the object 5 to be observed in the placement unit 221 so that there is sufficient illumination. An optical lens 41 of the microscopic image capturing device 4 then captures an image. Through a signal transmitting unit 42, which is exemplified in this embodiment as a wireless transmission module and which employs a wireless transmission technique such as ZigBee or WIFI, the image captured by the optical lens 41 is transmitted to a display processing device in the hand of an observer for display so as to enable the observer to conveniently and clearly observe the progress of the experiment. The display processing device in this embodiment is exemplified as a tablet computer 6. In addition, the placement unit 221 in this embodiment is not a completely enclosed one, but has a placement opening (not shown) in an upper portion thereof. To prevent the object 5 to be observed from escaping from the placement unit 221 through the placement opening, a light-transmissive shield (not shown) can be additionally provided on the placement opening of the placement unit 221 to restrict the maximum range of movement of the object 5 to be observed so as to facilitate the carrying out of experiments by the observer.

In addition, as can be seen from the side view of this embodiment, the main support frame 22 secured by the base body 1 is slightly inclined and is not completely parallel to the gravitational direction. To facilitate description herein, the main support frame 22 is described to be extending along an up-and-down direction corresponding to the gravitational direction so as to define the state in which the main support frame 22 is disposed. Certainly, those skilled in the art may modify the configuration by, for example, having the main support frame 22 disposed at 90 degrees so that it is completely perpendicular to the base body 21 or at other degrees, without obstructing the implementation of the technique according to the present invention.

The microscopic image capturing device 4 further includes a second coupling portion 43 that is exemplified as a housing having a specific size for firmly mounting in a main assembly port 222 formed on the main support frame 22. In this embodiment, the main assembly port 222 is exemplified as a receiving recess of a size corresponding to the aforesaid specific size. Through a mutually matching structural design, the microscopic image capturing device 4 can be firmly mounted on the main support frame 22 and prevented from undesired movement by virtue of the second coupling portion 43 that matches the main assembly port 222, thereby reducing the complexity of experiments. Those skilled in the art may modify it to be any size without affecting the implementation of this embodiment. Furthermore, when the microscopic image capturing device 4 is mounted in the main assembly port 222 of the main support frame 22, the main assembly port 222 is configured such that an optical axis 44 of the microscopic image capturing device 4 is oriented toward and corresponds to the placement unit 221. By virtue of such configuration, the optical lens 41 of the microscopic image capturing device 4 is oriented toward the placement unit 221 in an aligned manner along the direction of the optical axis 44. Moreover, through the inherent focus adjusting function of the optical lens 41, even if the placement unit 221 is not initially disposed at the focal point of the optical lens 41, the optical lens 41 may still automatically change the focal length to capture preferred image information, thereby enhancing the efficiency of the experimental operation.

Although the optical lens 41 itself has a focus adjusting function, sometimes it is difficult to ensure that the placement unit 221 can accurately fall on the focal point of the optical lens 41. Therefore, the main support frame 22 in this embodiment further includes an elevating unit 224 to enable the placement unit 221 to displace upwardly and downwardly relative to the base body 21 by virtue of the elevating unit 224, such that required images of the entire object 5 to be observed in the placement unit 221 can be captured by the optical lens 41. Furthermore, as the microscopic image capturing device 4 should always be maintained in a ready-to-capture state regardless of whether an experiment is being carried out or not, it is relatively important to maintain the operation of the microscopic image capturing device 4. For this purpose, the microscopic image capturing device 4 in this embodiment further has a power supply unit 45 which is exemplified as a battery. Even if the power of the power supply unit 45 is exhausted during the process of the experiment, the observer can easily replace it with a new one so as to prolong the operation time of the experiment.

The light source 3 in this embodiment further includes a first coupling portion 31. The first coupling portion 31 and the second coupling portion 43 are compatible with each other. Moreover, the first coupling portion 31 is similarly exemplified as a housing having a specific size. The light source 3 is mounted in a corresponding assembly port 223 formed on the main support frame 22 by means of the first coupling portion 31. The corresponding assembly portion 223 and the main assembly port 222 are compatible with each other and are correspondingly disposed on opposite sides of the placement unit 221. The corresponding assembly port 223 in this embodiment is similarly exemplified as a receiving recess of a size corresponding to the aforesaid specific size. It should be noted that the aforementioned term “compatible” refers to fully matching without any difference.

Therefore, the light source 3 can likewise be firmly mounted on the main support frame 22 by virtue of the first coupling portion 31 that matches the corresponding assembly port 223. On the other hand, when the light source 3 is disposed in the corresponding assembly port 223 of the main support frame 22, a main light emitting direction 32 of the light source 3 is oriented toward the placement unit 221 in an aligned manner. Since the light emitted by the light source 3 will scatter in all directions, only light that is entirely oriented toward the placement unit 221 can be effectively utilized. For the sake of simplification, the term “light emitting direction 32” is used to define the light that is emitted by the light source 3 and that is oriented entirely toward the placement unit 221.

Certainly, those skilled in the art may also switch the positions of the corresponding assembly port and the main assembly port, from the initial upright microscope (in which the light source is below the placement unit and the microscopic image capturing device is above the placement unit) to the inverted microscope (in which the light source is above the placement unit and the microscopic image capturing device is below the placement unit), without affecting the implementation of this embodiment.

From the above description of this embodiment, it can be seen that the present invention has several characteristics. By virtue of the main assembly port formed in the main support frame and the second coupling portion that matches the main assembly port, the observer can do the assembly at will, thereby avoiding the prior art drawback that, due to limited experiment budgets, numerous observation experiments are completed using only a small number of optical microscopes, which may lead to experiment data discrepancies. Furthermore, in the prior art, when a component of an optical microscope is damaged, the microscope is discarded and a new optical microscope need be brought. For the observer, this undoubtedly increases cost. In the present invention, as the components can be freely assembled, even if a component of the optical microscope is accidentally damaged, it is only necessary to replace the damaged component, thereby providing a cost-saving optical microscope, as well as enhancing the use flexibility of the optical microscope. On the other hand, to maintain the efficiency of experiments, when the microscopic image capturing device cannot effectively obtain a focal length, the elevating unit in this embodiment allows the position of the placement unit to be freely adjusted so as to obtain an effective focal length, thereby enabling the microscopic image capturing device to capture clear images of the object to be observed. Moreover, by virtue of the signal transmitting unit of the microscopic image capturing device which outputs obtained images to the tablet computer, the observer can easily identify the progress of the experiments, and the operational convenience in experiments can be enhanced.

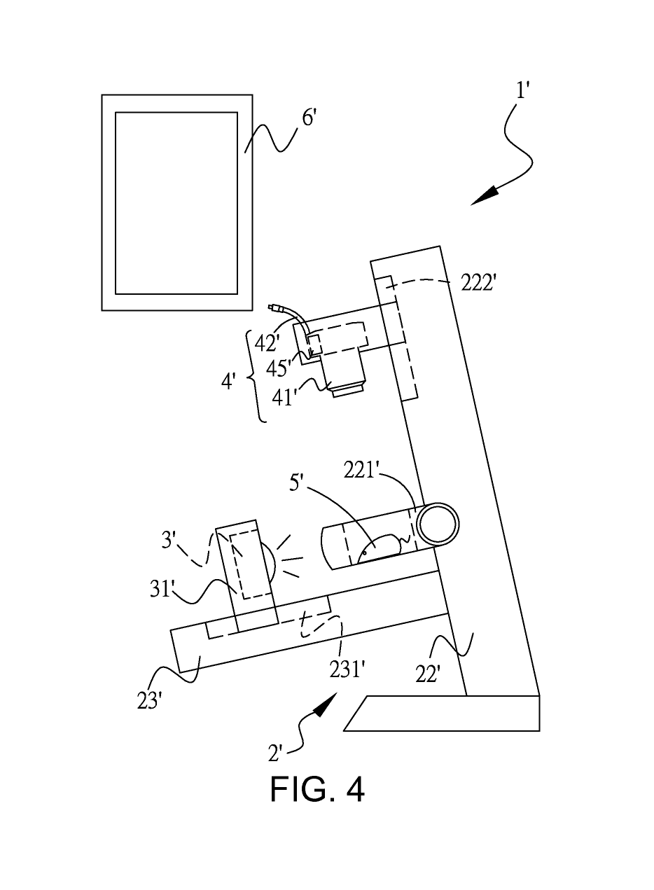

FIG. 4 shows a microscope 1′ according to the second preferred embodiment of the present invention, which differs from the previous embodiment in that the combinable microscope base 2′ in this embodiment further includes an auxiliary support frame 23′. The auxiliary support frame 23′ is connected to the main support frame 22′ of the previous embodiment. It can be seen from the side view that the auxiliary support frame 23′ and the main support frame 22′ form a substantially T-shaped profile. Furthermore, the auxiliary support frame 23′ is provided with an auxiliary assembly port 231′ distal from the main support frame 22′. The auxiliary assembly port 231′ is compatible with the main assembly port 222′ of the previous embodiment, and the auxiliary assembly port 231′ is likewise exemplified as a receiving recess having a size corresponding to the specific size.

In a fluorescence test experiment, to facilitate observation of an object 5′ to be observed as in the previous embodiment (an introduced gene often will produce a fluorescent protein), the observer may mount the light source 3′ having the first coupling portion 31′ as in the previous embodiment in the auxiliary assembly port 231′ of the auxiliary support frame 23′. The light source 3′ in this embodiment is exemplified as an excitation light source capable of exciting fluorescence. Through the arrangement of the auxiliary assembly port 231′, the light source 3′ is oriented toward the placement unit 221′ supporting the object 5′ to be observed for irradiation. At this time, the fluorescent gene introduced into the object 5′ to be observed will be excited by the light of the light source 3′ to emit fluorescence, and the optical lens 41′ of the microscopic image capturing device 4′ as in the previous embodiment captures a fluorescent image of the object 5′ to be observed, which is transmitted by a signal transmitting unit 42′, exemplified as a transmission cable in this embodiment, to a tablet computer 6′ as in the previous embodiment. Since noise light from the outside must be limited in a fluorescence experiment to prevent entry of outside light that may overshadow the fluorescence intended to be observed, a shield (not shown) may be additionally provided to block out outside light so as to considerably reduce entry of any background noise light that would interfere with operation and observation in experiments. In addition, the power supply unit 45′ of the microscopic image capturing device 4′ in this embodiment is exemplified as a power cable which is connected to a municipal power source to obtain sufficient electric power so as to avoid power depletion that may affect the efficiency of experiments. Certainly, the microscopic image capturing device may also make use of the signal transmitting unit in this embodiment which, other than transmitting data, can provide electric power for operation through the tablet computer, without affecting the implementation of this embodiment.

In addition, before carrying out an experiment, another microscopic image capturing device can be mounted in the corresponding assembly port to ensure that the optical axis of the microscopic capturing device mounted in the main assembly port is indeed oriented toward the placement unit. By virtue of such arrangement and configuration, the observer can easily find out whether the optical lens of the microscopic image capturing device has deviated and can immediately attend to any necessary correction, thereby enhancing the efficiency of the experiments.

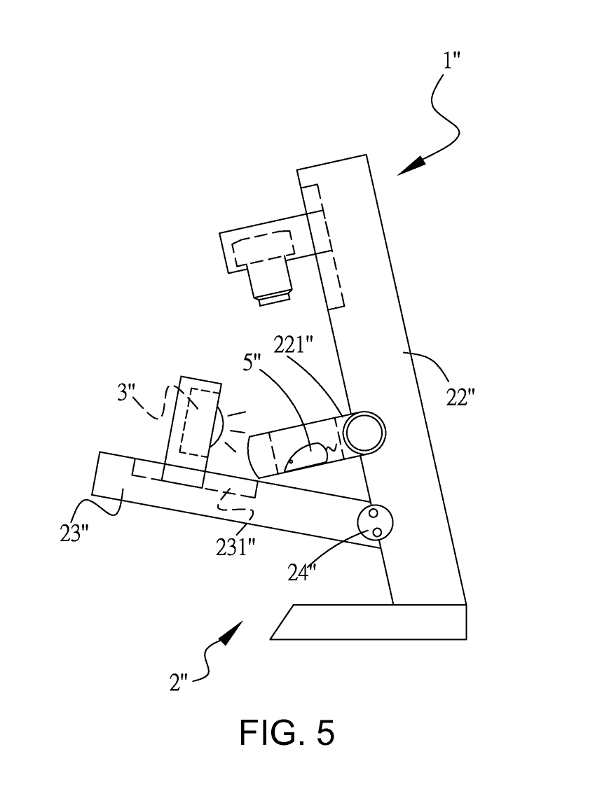

FIG. 5 shows a microscope 1″ according to the third preferred embodiment of the present invention. The combinable microscope base 2″ further has an angle adjusting member 24″ for coupling the auxiliary support frame 23″ to the main support frame 22″. By virtue of the arrangement of the angle adjusting member 24″, the auxiliary support frame 23″ can pivotally turn relative to the main support frame 22″ such that the light source 3″, which is disposed in the auxiliary assembly port 231″ and which is exemplified to be capable of exciting fluorescence as in the previous embodiment, can irradiate light on the object 5″ to be observed in the placement unit 221″ from a low angle, thereby avoiding the prior art problem that directly reflected light may overshadow the fluorescence intended to be observed.

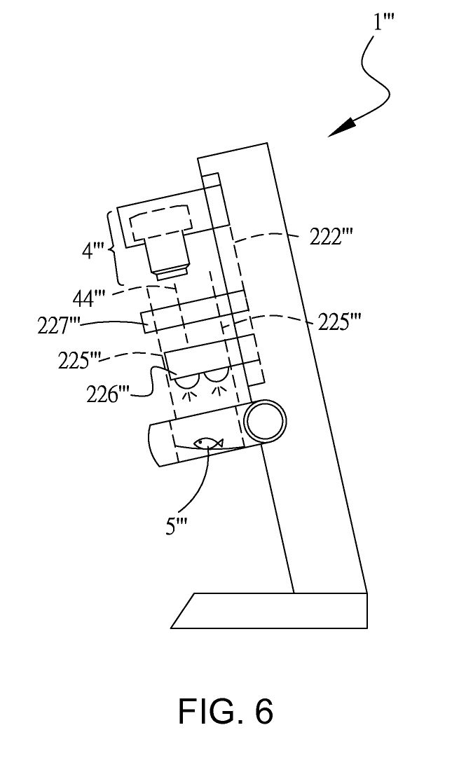

FIG. 6 shows a microscope 1′ according to the fourth preferred embodiment of the present invention. The main assembly port 222′″ in this embodiment is further formed with an optical path 225′″ corresponding to the optical axis 44′″ of the microscopic image capturing device 4′″, and the main assembly port 222′″ further includes an auxiliary light source 226″, which is exemplified as infrared light, and a filter lens 227′″ disposed on the optical path 225′″. In this embodiment, the filter lens 227′″ is a rotatable replaceable disk structure. Before carrying out an experiment, the auxiliary light source 226′″ mounted in the main assembly port 222′″ can be turned on first. After the microscopic image capturing device 4′″ is caused to capture an infrared image to confirm that the object 5′″ to be observed, which is exemplified as zebrafish, is indeed located in the range of the lens, the auxiliary light source 226′″ is turned off. Moreover, the filter lens 227′″ used is changed to a filter lens that allows passage of, for example, green light only, therethrough, and another blue light excitation light source (not shown) is turned on. By using the filter lens 227′″ to filter out scattered light, including excitation light, and other background noise light, the microscopic image capturing device 4′″ can easily capture the necessary green fluorescent images.

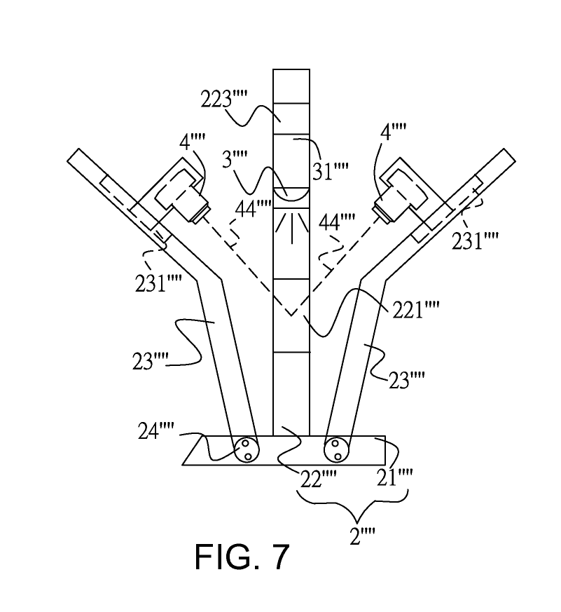

FIG. 7 shows the fifth preferred embodiment of the present invention. The combinable microscope base 2″″ in this embodiment further has two auxiliary support frames 23″″ disposed symmetrically and respectively on two sides of the main support frame 22″″ and connected to the base body 21″″ through the angle adjusting member 24″″. The light source 3″″, exemplified as an LED light-emitting element, is mounted in the corresponding assembly port 223″″ in the main support frame 22″″ through the first coupling portion 31″″ so as to supply sufficient illumination. Through the free assembling technique of the present invention, the present invention can replace conventional stereo microscopes available in the marketplace. As the configuration of the auxiliary assembly ports 231″″ is the same as that of the third preferred embodiment, a description thereof is dispensed with herein for the sake of brevity. The difference is that, in this embodiment, the auxiliary assembly ports 231″″ are respectively provided with microscopic image capturing devices 4″″. The optical axes 44″″ of the microscopic image capturing devices 4″″ are respectively oriented toward the corresponding placement unit 221″″ such that the optical axes 44″″ can meet at the corresponding placement unit 221″″, and the two microscopic image capturing devices 4″″ can form an angle therebetween to simulate the viewing angles of human eyes. In the drawing, the angle between the two microscopic image capturing devices 4″″ is exaggerated to facilitate illustration. In actual operation, the image data obtained by the two microscopic image capturing devices 4″″ are synthesized on, for example, a goggle-type screen (not shown) to allow the eyes of the operator to respectively observe two images of the object to be observed obtained with an angle therebetween so as to achieve a stereoscopic effect, thereby further enhancing the use flexibility of the present invention.

In the combinable microscope base and the microscopic having said base as disclosed herein, the placement unit, the microscopic image capturing device, and the light source which are otherwise mounted fixedly are configured such that their mounting positions can be changed at will.

Such a structural configuration allows the main assembly port of the main support frame to be located at the center of weight of the entire optical microscope, thereby solving the prior art problem that the operating space of the placement unit is limited. Furthermore, due to the arrangement of the angle adjusting member, the situation in which the emitted fluorescence is too weak when light of the excitation light source disposed on the auxiliary support frame is irradiated on the object to be observed can be avoided. Whether in comparison with incident light or directly reflected light, or even scatteredly reflected light, the difference in light intensity is very obvious. The provision of multiple filter lenses in the prior art to filter out reflected light in view of the problem of direct reflection inevitably results in the filtering out of some of the fluorescence required for experiments so that a lens with a multiplication factor need be additionally installed to facilitate naked-eye observation of fluorescence. Through the improvements provided herein, the use flexibility of the microscope can be enhanced, without the need to use expensive conventional fluorescence microscopes that could cost more than RMB 200,000, thereby considerably reducing experiment cost and enhancing the efficiency and accuracy of experiments.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A combinable microscope base for mounting at least one light source and at least one microscopic image capturing device having an optical axis, said light source and said microscopic image capturing device being connected to a display processing device through signal transmission, said light source and said microscopic image capturing device respectively having a first coupling portion and a second coupling portion that are compatible with each other, said combinable microscope base comprising:
a base body;
a main support frame secured on said base body and extending along an up-and-down direction corresponding to a gravitational direction, said main support frame being formed with a placement unit and at least one main assembly port, wherein said placement unit is disposed to secure and support an object to be observed, and said at least one main assembly port matches said first coupling portion and said second coupling portion and is disposed for mounting at least one said microscopic image capturing device or said light source; and
an auxiliary support frame connected to said base body or said main support frame, said auxiliary support frame being provided with an auxiliary assembly port that is distal from said base body or said main support frame, that is compatible with said main assembly port, and that matches said first coupling portion and said second coupling portion;
wherein said main assembly port which is disposed for mounting at least one said microscopic image capturing device or said light source is configured such that when said at least one microscopic image capturing device or said light source is mounted, said optical axis of said at least one microscopic image capturing device or a main light emitting direction of said light source is oriented toward and corresponds to said placement unit.

2. The combinable base according to claim 1, further comprising an angle adjusting member for coupling said auxiliary support frame to said base body or said main frame such that said auxiliary support frame is pivotally turnable relative to said base body or said main support frame.

3. The combinable microscope base according to claim 1, wherein said main support frame further has a corresponding assembly port that is compatible with said main assembly port, said corresponding assembly port being disposed for mounting the other one of said microscopic image capturing device or said light source, said corresponding assembly port and said main assembly port being located on opposite sides of said placement unit.

4. A microscope having a combinable microscope base and connected to a display processing device through signal transmission, said microscope comprising:
at least one microscopic image capturing device having at least one optical lens, a signal transmitting unit, a power supply unit, and a second coupling portion, said optical lens being disposed to capture an image of an object to be observed, and to output information of said image of said object to be observed to said display processing device through said signal transmission unit;
at least one light source for irradiating light toward a position of said object to be observed and having a first coupling portion which is compatible with said second coupling portion; and
a combinable microscope base, including:
a base body; and
a main support frame secured on said base body and extending along an up-and-down direction corresponding to a gravitational direction, said main support frame being formed with a placement unit and at least one main assembly port, wherein said placement unit is disposed to secure and support an object to be observed, and said at least one main assembly port matches said first coupling portion and said second coupling portion and is disposed for mounting at least one said microscopic image capturing device or said light source;
wherein said main assembly port which is disposed for mounting at least one said microscopic image capturing device is configured such that when said at least one microscopic image capturing device or said light source is mounted, said optical axis of said at least one microscopic image capturing device or a main light emitting direction of said light source is oriented toward and corresponds to said placement unit.

5. The microscope having said combinable microscope base according to claim 4, further comprising:
an auxiliary support frame connected to said base body or said main support frame, said auxiliary support frame being provided with an auxiliary assembly port that is distal from said base body or said main support frame, that is compatible with said main assembly port, and that matches said first coupling portion and said second coupling portion; and
an angle adjusting member for coupling said auxiliary support frame to said base body or said main frame such that said auxiliary support frame is pivotally turnable relative to said base body or said main support frame.

6. The microscope having said combinable microscope base according to claim 4, wherein said main support frame further includes an elevating unit to guide said placement unit to displace upwardly or downwardly relative to said base body, and a corresponding assembly port compatible with said main assembly port, said corresponding assembly port being disposed for mounting said light source having said first coupling portion, said corresponding assembly port and said main assembly port being located on opposite sides of said placement unit.

7. The microscope having said combinable microscope base according to claim 6, wherein each of said first coupling portion and said second coupling portion is a housing having a specific size, each of said main assembly port, said corresponding assembly port, and said auxiliary assembly port being a receiving recess corresponding to said specific size.

8. The microscope having said combinable microscope base according to claim 4, wherein said main assembly port is formed with an optical path corresponding to said optical axis of said microscopic image capturing device, said main assembly port further including an auxiliary light source and a filter lens disposed on said optical path.

9. The microscope having said combinable microscope base according to claim 4, further comprising two of said auxiliary support frames connected to said base body or said main support frame, said two auxiliary support frames being symmetrically and respectively disposed at two sides of said main support frame, and being each provided with an auxiliary assembly port which is compatible with said main assembly port and which matches said first coupling portion and said second coupling portion, wherein said main assembly port has one said light source mounted therein, and said two auxiliary assembly ports respectively have two of said microscopic image capturing devices mounted therein, optical axes of said two microscopic image capturing devices being respectively oriented toward and corresponding to said placement unit such that said optical axes of said two microscopic image capturing devices meet at said placement unit.
